(19) United States
(12) Patent Application Publication
(10) Pub. No.: US 2011/0031735 A1
(43) Pub. Date: Feb. 10, 2011

(54) SECURITY ELEMENT

(75) Inventors: Markus Gerigk, Koln (DE); Ludger Brüll, Leverkusen (DE); Andreas Bäcker, Wuppertal (DE); Thomas Birsztejn, Dormagen (DE); Simon Vougioukas, Koln (DE); Josef Kenfenheuer, Bergisch Gladbach (DE); Georgios Tziovaras, Wuppertal (DE); Dirk Pophusen, Bergisch Gladbach (DE); Mehmet Cengiz Yesildag, Leverkusen (DE); Heinz Pudleiner, Krefeld (DE)

Correspondence Address: Hildebrand, Christa;Norris McLaughlin & Marcus PA, 875 Third Avenue, 8th Floor, New York, NY, 10022, US

(73) Assignee: BAYER TECHNOLOGY SERVICES GMBH, Leverkusen (DE)

(21) Appl. No.: 12/865,227

(22) PCT Filed: Jan. 24, 2009
(86) PCT No.: PCT/EP09/00450

§ 371 Date: Oct. 4, 2010

(30) Foreign Application Priority Data
Feb. 5, 2008 (DE) 10 2008 007 731.3
Apr. 2, 2008 (DE) 200810106803
Oct. 11, 2008 (DE) 200810051409

(51) Int. Cl. B42D 15/00

(52) U.S. Cl. 283/70; 283/74

(57) ABSTRACT

The invention relates to optical security elements, their use for identifying and authenticating objects and processes and devices for identifying and authenticating objects using the optical security elements.

The present invention relates to optical security elements, to their use for the identification and authentication of objects and to methods and devices for identifying and authenticating objects using these optical security elements.

Identity cards, bank notes and products etc. are today provided with anti-counterfeiting elements which can only be copied using specialized know-how and/or a high degree of technical effort. Such elements are referred to as security elements in the present context. Security elements are preferably inseparably connected to the objects to be protected. Any attempt to separate security elements from the objects should result in their destruction in order to prevent their improper use.

The authenticity of an object can be checked by the presence of one or more security elements.

Optical security elements, such as, for example, watermarks, special inks, guilloché patterns, microtexts and holograms are globally well-established features. An overview of optical security elements which are, in particular, not exclusively suitable for document protection, is contained in the following book: Rudolf L. van Renesse, Optical Document Security, Third Edition, Artech House Boston/London, 2005 (pp. 63-259).

Depending on how authenticity is checked, optical security elements can be subdivided into the following categories:
Class 1: Visible (overt)—the security element is visible to the human eye and can therefore be checked simply and without any aids. Visible security elements allow any person to check the authenticity of an object in a first “obviousness test”.
Class 2: Invisible (covert)—the security element is invisible to the human eye. A (simple) device is necessary for checking authenticity.
Class 3: Forensic—authenticity is checked by means of special equipment.

The above categories provide a qualitative indication of the amount of effort required for counterfeiting such elements, which is why they are referred to as (security) classes.

Several security elements are often used in combination for safeguarding objects requiring protection. For cost reasons it is often advantageous to integrate several security features in one single element, instead of providing an object requiring protection with several different security elements. In DE 10232245 A1 a special optically variable device (OVD) is, for example, described which, due to a thin film layer assembly containing at least one spacer layer, produces colour shifts by interference and which can additionally be provided with diffractive structures for increasing security. Both the colour shift produced by interference and diffraction phenomena resulting from the diffractive structures can be detected by the human eye. This device is therefore a combination of two (class 1, overt) features.

It would be advantageous to be able to combine all the abovementioned security classes in one single security element.

The greater the degree of effort required to produce a security element, the greater the effort usually required to forge such an element. Thus, complicated security elements usually provide greater protection than simple security elements. Complicated security elements are today mainly used for highly valuable products, since the high amount of effort required for producing the elements does of course also affect the cost of the products. The use of security elements is not worthwhile for many consumer goods. It would however be advantageous for security elements to be available which can be produced and used at low cost while at the same time providing high protection against forgery, so that less highly valuable products, such as consumer goods, can also be protected.

Due to the ready availability and high quality of reproductions, which can be obtained using modern colour copying machines or with high resolution scanners and colour laser printers, the need exists to constantly improve the non-forgeability of optical security features.

Optically variable security elements are known which produce different optical impressions from different viewing angles. Such security elements have, for example, optical diffraction patterns which reconstruct different images at different viewing angles. Such effects cannot be reproduced by conventional commonly used copying and printing techniques. One special variant of such a diffractive optically variable image device (DOVID), a so-called embossed hologram, is described in DE 10126342 C1. Embossed holograms are characterized in that the light-diffracting pattern is converted into a three-dimensional relief pattern which is transferred to an embossing die. This embossing die can be impressed in plastic films as a master hologram. This allows the low cost production of a large number of security elements. The disadvantage of this is, however, that many products are not provided with visible holograms for design or aesthetic reasons. Although perfume bottles are objects which are regularly counterfeited on a large scale, these products do not contain holograms, since they evidently do not, for marketing reasons, fit their image. It would therefore be advantageous for security elements to be available which can also be integrated in (design) products without having a disadvantageous effect on the “image” of the product.

The disadvantage of the abovementioned embossed holograms is also that they cannot be machine-checked for their authenticity. In order to avoid gaps in the supply chain it is necessary to be able to confirm authenticity quickly and reliably at various points. Usually optical codes, such as for example bar codes, are used for “tracking and tracing” products. Bar codes are, however, elements which are purely used for tracking and tracing an object without displaying any security features. They are easy to copy and forge. RFID chips provide a combination of features for tracking and tracing products. Due to their relatively high costs, slow reading speed and sensitivity towards electromagnetic interference fields they can, however, only be used to a limited degree. It would therefore be advantageous for a security feature to be provided which is machine-readable in order to allow not only the automatic tracking and tracing of products throughout the supply chain but also the automatic checking of their authenticity (=by machine). An examination of authenticity merely by machine is not sufficient, since the end customer should also be able to check the authenticity of an object from the security feature employed. End customers will usually check for authenticity without the aid of a device, i.e. merely by using their natural senses.

A further disadvantage of embossed holograms is that those security elements used according to the prior art cannot be individualized. The embossed holograms are non-distinguishable. This means not only that a counterfeiter only has to copy/forge one single master hologram in order to obtain a large number of embossed holograms for counterfeited products, but also that objects cannot be individualized by means of the embossed holograms due to their indistinguishability.

For reasons of improved protection against forgery and the possibility of tracking and tracing individual objects it is preferable to use security features which can be individualized, i.e. which have individual security features for each product to be protected. Individual features are understood to be, for example, a serial number, the date of manufacture or, in the case of personal security documents, a name, an ID number or a biometric feature. The combination of individual features with security features which are only identifiable with difficulty or with a great deal of effort, is known from the prior art. One individualizable security element is for example described in EP 0 896 260 A3, in which individualization is carried out during the production of the security element and individuality is based on a deterministic process. The choice of the parameters for the production of the security element clearly and reproducibly determines the design of the security element. Deterministic individuality has the disadvantage that it can be fundamentally reproduced/copied, since the individual features are produced by a specific reproducible process. In addition, variability is usually restricted in a deterministic process, i.e. only a limited number of individual features can be produced with a limited set of parameters, so that only a limited number of objects can be rendered distinguishable.

Protection against forgery and the number of objects which can be distinguished is usually higher in the case of security elements which have random features than in the case of security features with purely deterministic features.

WO2005088533A1 describes a process in which objects having a fibrous structure (such as for example paper) are clearly recognizable by their random surface properties. In this process, a laser beam is focussed on the surface of the object, moved over the surface and the beams scattered to different degrees and at different angles from different areas of the surface are detected by photodetectors. The scattered radiation detected is characteristic of a large number of different materials and is individual for each surface. It is very difficult to reproduce since it is based on random variables during the production of the object. The scattering data for the individual objects are stored in a database in order to be able to authenticate the object at a later point in time. For this purpose the object is re-measured and the scattered data compared with the stored reference data. The disadvantage of this process is that only objects with a sufficiently large number of random scattering centres can be detected. In addition, authentication always requires the use of the process concerned and thus a corresponding device. It is not possible for any person holding such an object in his or her hands to conduct an obviousness test of the authenticity of the object.

Based on the existing prior art the problem therefore arose of providing a security element in which security features of varying security classes are used in combination. Security features are preferred which contain all of the abovementioned (overt, covert and forensic) classes. The security element should therefore not only be in a form which can be tested for obvious forgery by a person (in an “obviousness” test) without the use of aids (device) merely by the use of his or her senses (i.e. in an overt form), but it should also at the same time contain features of higher (covert and forensic) security classes which make forgery difficult and can be detected with the aid of corresponding aids. The security element should be capable of being checked by a machine and should be individualizable. The security element should contain at least one feature of a random nature in order to guarantee maximum protection against forgery and to simultaneously allow differentiation of a large number of objects. The security element should be inexpensive and should be capable of being attached to a large number of objects without having a negative effect on their design. The process of authentication and/or identification of the security element should be capable of being conducted automatically and quickly. The device for authenticating and/or identifying the security element should be inexpensive and capable of being operated by any person after only a very short demonstration, without the need for any specialist knowledge.

Surprisingly it has been found that this problem can be solved by a security element comprising at least one layer containing a large number of randomly distributed and/or orientated microreflectors.

The present invention therefore relates to a security element comprising at least one transparent layer in which a large number of microreflectors are randomly distributed, characterized in that at least some of the microreflectors have at least one reflective surface which is not arranged parallel to the surface of the transparent layer.

The security element is characterized in that it comprises at least one layer which is transparent to electromagnetic radiation with at least one wavelength. Transparency is understood to mean that the portion of electromagnetic radiation with at least one wavelength which penetrates the layer is greater than the sum of the portions of electromagnetic radiation with at least one wavelength which are absorbed by the layer or reflected from the boundary surfaces of the layer. The transmittance of the layer, i.e. the ratio between the intensity of the electromagnetic radiation with at least one wavelength which passes through the layer and the intensity of the electromagnetic radiation with at least one wavelength which impinges on the layer, is thus greater than 50%. In the following such a layer is referred to as the transparent layer.

The transmittance of the transparent layer for at least one wavelength is preferably between 60% and 100%, and particularly preferably between 80% and 100%.

Preferably the at least one wavelength of electromagnetic radiation for which the at least one layer of the security element according to the invention has the abovementioned property of transparency, is in the range between 300 nm and 1,000 nm, and particularly preferably between 400 nm and 800 nm.

In a preferred variant, the transparent layer of the security element according to the invention has a transmittance of at least 60% for electromagnetic radiation with a wavelength between 400 and 800 nm.

The transparent layer of the security element according to the invention has a thickness of between 1 μm and 1 cm. The layer thickness is preferably in the range between 1 μm and 1 mm, and particularly preferably between 10 μm and 500 μm.

The transparent layer consists preferably of glass, a ceramic material or a plastic.

The transparent layer is preferably a film, which consists of a lacquer, or a foil. A film and a foil are characterized in that one of their three spatial dimensions (their thickness) is at least 10, and preferably at least 100 times smaller than the two remaining spatial dimensions (length and width) of their volume. A lacquer is a liquid or pulverulent coating material which is applied thinly to articles and forms a continuous film as a result of chemical or physical processes (such as for example the evaporation of the solvent or the polymerization of monomers or oligomers contained in the lacquer etc.). A foil is a solid body which is capable of being wrapped onto or around articles.

In a preferred variant of the security element according to the invention a thermoplastic material in the form of a foil is used as the transparent layer. Foils of thermoplastic materials which are suitable according to the invention are, for example, those produced from known thermoplastic aromatic polycarbonates having weight average molecular weights Mw of from 25,000 to 200,000, preferably from 30,000 to 120,000 and in particular from 30,000 to 80,000 (Mw determined by eta rel in dichloromethane at 20° C. and a concentration of 0.5 g per 100 ml) and those produced from known thermoplastic polyarylsulphones which can be linear (see DE-OS 27 35 144) or branched (see DE-OS 27 35 092 or DE-OS 23 05 413).

Foils which are also suitable are those of thermoplastic cellulose esters, thermoplastic polyvinyl chlorides, thermoplastic styrene/acrylonitrile copolymers and thermoplastic polyurethanes.

Suitable cellulose esters are obtained by conventional processes by esterifying cellulose with aliphatic monocarboxylic acid anhydrides, preferably acetic acid and butyric acid or acetic acid and propionic acid anhydride.

Thermoplastics which are also suitable are, for example, poly- or copolyacrylates and poly- or copolymethacrylates, such as for example and preferably polymethyl methacrylate (PMMA), polymers or copolymers with styrene, such as for example and preferably transparent polystyrene (PS) or polystyrene acrylonitrile (SAN), transparent thermoplastic polyurethanes, and polyolefins, such as for example and preferably transparent types of polypropylene or polyolefins based on cyclic olefins (e.g. TOPAS® from Topas Advanced Polymers), poly- or copolycondensates of terephthalic acid, such as for example and preferably poly- or copolyethylene terephthalate (PET or CoPET) or glycol-modified PET (PETG), polyethylene glykol naphthenate (PEN) and transparent polysulphones (PSU).

Suitable linear polyarylsulphones are all known aromatic polysulphones or polyether sulphones with Mw (weight average molecular weight measured for example by light scattering) of between about 15,000 and about 55,000, and preferably between about 20,000 and about 40,000. Such polyarylsulphones are described for example in DE-OS 17 19 244 and U.S. Pat. No. 3,365,517. Suitable branched polyaryl sulphones are in particular the branched polyarylether sulphones according to DE-OS 23 05 413 and U.S. Pat. No. 3,960,815, whose Mw (weight average molecular weight, measured for example by light scattering) is between about 15,000 and about 50,000, and preferably between about 20,000 and 40,000. (For further details in this regard see DE-AS 30 10 143).

Suitable thermoplastic polyvinyl chlorides are for example the PVC types available on the market.

Suitable thermoplastic styrene/acrylonitrile copolymers are copolymers of styrene and preferably acrylonitrile, which are obtained for example by suspension polymerization, in the presence of catalysts, of the monomers or a mixture of the monomers with Mw of 10,000 to 600,000 (Mw is measured in DMF at C=5 g/l and 20° C.). For literature on this subject see “Beilsteins Handbuch der organischen Chemie” (Beilstein's Manual of Organic Chemistry), fourth edition, Third Supplement B 1.5, pp. 1163-1169, Publishers: Springer Verlag 1964 and H. Ohlinger, “Polystyrol 1. Teil, Herstellungsverfahren and Eigenschaften der Produkte” (Polystyrene, Part 1, Manufacturing Processes and Properties of the Products), Publishers: Springer Verlag (1955).

The thermoplastic resins, such as for example styrene/acrylonitrile or alpha-methylstyrene/acrylonitrile copolymers can be produced by known methods, e.g. by bulk polymerization, solution polymerization, suspension polymerization and emulsion polymerization.

Cycloolefin copolymers are described in the patents from Mitsui Chemicals U.S. Pat. No. 5,912,070 and Ticona GmbH EP 765 909.

With regard to the production of the laminated materials, and in particular the foils, reference can be made to DE-OS 25 17 033 and DE-OS 25 31 240.

It is also possible to use thermoplastic polyurethanes for producing the layers according to the invention.

The foils can be matt or structured on one side. This is obtained, for example, by pressing the melt of the thermoplastic material through a slot die and pulling off the web of melt over a matt or structured cooling roller.

The thermoplastic layer can either be a monolayer of such plastics or a multi-layered plastic layer consisting of individual layers of various plastics each with a thickness of 0.001 to 1 mm.

A security element according to the invention also comprises a large number of microreflectors which are distributed and/or oriented randomly within the transparent layer.

Random distribution and/or orientation is understood to mean that the position of individual microreflectors and/or the orientation of individual microreflectors within the transparent layer cannot be predictably predetermined by the manufacturing process. The position and/or orientation of individual microreflectors is/are subject to random variations during the manufacturing process. The position and/or orientation of individual microreflectors cannot therefore be readily reproduced. This is the essence of the high protection provided by the security features according to the invention: they can only be copied with a very high degree of effort. In a preferred variant both their position (the distribution of the microreflectors within the transparent layer) and their orientation are of a random nature. Random is not to be understood in a strictly mathematical sense but means that a degree of randomness exists which makes it impossible to precisely predict the position and orientation of individual microreflectors. It is however possible for microreflectors to have a preferred position and/or orientation. The distribution of the microreflectors around this position and/or orientation can be determined by the manufacturing process, although the position and/or orientation of each individual microreflector remains uncertain.

A microreflector according to the invention is characterized in that it has at least one surface which reflects the incident electromagnetic radiation in a characteristic manner. This characteristic reflection is characterized in that electromagnetic radiation with at least one wavelength is reflected in at least one direction predetermined by the angle of incidence, the portion of reflected radiation with at least one wavelength being greater than the sum of the portions of absorbed and transmitted radiation with at least one wavelength. The degree of reflection of the at least one surface is therefore greater than 50%, the degree of reflection being understood to be the ratio between the intensity of the electromagnetic radiation with at least one wavelength which is reflected back by the surface and the intensity of the electromagnetic radiation with at least one wavelength which impinges on the surface. In the following such a surface is referred to as a reflective surface.

Preferably the degree of reflection of the reflective surface of the microreflector for at least one wavelength is between 60% and 100%, and particularly preferably between 80% and 100%.

Preferably the at least one wavelength of electromagnetic radiation for which the at least one surface of a microreflector of the security element according to the invention has the abovementioned property of reflectivity is in the range between 300 nm and 1,000 nm, and particularly preferably between 400 nm and 800 nm.

In a preferred variant, the reflective surface of a microreflector of the security element according to the invention has a degree of reflection of at least 60% for electromagnetic radiation with a wavelength of between 400 and 800 nm.

This reflection is preferably specular (directional) reflection and/or diffraction, i.e. the fraction of diffusely reflecting radiation (scattering) is preferably less than 50%, and particularly preferably less than 40%. Diffracted and specularly reflected radiation are both referred to as reflected radiation in the present context.

The reflective surface of a microreflector has a size of between 1×10⁻¹⁴ m² and 1×10⁻⁵ m². Preferably the size of the reflective surface is in the range between 1×10⁻¹² m² and 1×10⁻⁶ m², and particularly preferably between 1×10⁻¹⁰ m² and 1×10⁻⁷ m².

The term “a large number of microreflectors” is to be understood as follows: If the transparent layer of the security element according to the invention is viewed from the top or from the bottom, an average of 1 to 1,000 microreflectors, and preferably between 10 and 100 microreflectors, is present over an area of 1 cm². The average distance between two microreflectors is preferably at least 5 times the average size of the reflective surface area of the microreflectors. In a particularly preferred variant the average distance is between 10 and 50 times the average size of the reflective surface of the microreactors. In the present context and in the following, average size refers to the arithmetical average of the corresponding dimension.

The reflective surface of a microreflector is flat or curved. If the surface is flat, a parallel bundle of rays impinging on the surface is also reflected back from the surface in a parallel form. If the surface is curved a parallel bundle of rays impinging on the surface is reflected back in the form of divergent rays (with a convex curvature) or convergent rays (with a concave curvature). Flat surfaces have the advantage that sharp reflection bands are produced over a narrow angle range (see for example FIG. 9). Curved surfaces have the advantage that reflections are produced over a wider angle range, but the bands are wider. Depending on the end use, flat or curved reflective surfaces are therefore preferred.

The reflective surface can be flat or it can have one or more structures which produce the diffraction of electromagnetic radiation.

The microreflectors can be approximately spherical, rod-shaped, parallelepiped-shaped, polyhedron-shaped or platelet-shaped or they can have any other conceivable shape. In a preferred variant of the security element according to the invention the microreflectors are platelet-shaped, i.e. their spatial extent in two dimensions is almost the same, whereas their spatial extent in the third dimension is at least 4 times smaller than their spatial extents in the two other dimensions. “Almost the same” means that the spatial extents differ by a factor of a maximum of 2. The surface which is formed by the spatial extent of a microreflector in the two dimensions with almost the same extent is preferably a reflective surface.

Surprisingly it has been found that when platelet-shaped microreflectors are used for the production of the security element by extrusion of a sheet containing microplatelets they have an orientational distribution which is particularly suitable for authenticating and identifying purposes. As a result of the extrusion process, platelet-shaped microreflectors have a preferential orientation parallel to the surface of the transparent layer. The orientation of individual microplatelets is still, however, to some extent random; the microplatelets do however have a greater tendency to be parallel to the surface of the transparent layer than perpendicular thereto; the orientation of the microplatelets is randomly distributed around an orientation parallel to the surface of the transparent layer.

Due to this preferential orientation the majority of the microreflectors are available for the process according to the invention for authenticating and/or identifying an object using the security element according to the invention. In a preferred variant the microreflectors therefore have a preferential orientation which is characterized in that their reflective surfaces are randomly orientated at angles in the range from 0 to 60° to the surface of the transparent layer. Preferably the angle of inclination of the reflective surfaces to the surface of the transparent layer is in the range between 0 and 50°, and particularly preferably between 0 and 30°.

In a preferred embodiment the microreflectors have a maximum longitudinal size of less than 200 μm, a thickness of 2-10 μm and a circular, elliptical or n-cornered shape with n≧3. In this context and in the following, elliptical does not have the strictly mathematical meaning. In the present context and in the following elliptical is also understood to refer to a rectangle or a parallelogram or a trapezium or, generally, an n-cornered shape with rounded corners.

In a preferred variant the microreflectors comprise at least one metallic component. The preferred metal is one from the series comprising aluminium, copper, nickel, silver, gold, chromium, zinc, tin and alloys of at least two of the aforementioned metals. The microreflectors can be coated with a metal or an alloy or can consist completely of a metal or an alloy.

In a preferred variant, metal identification platelets of the kind described for example in WO 2005/078530 Al are used as microreflectors. They have reflective surfaces. If a large number of such metal identification platelets are randomly distributed and/or oriented in a transparent layer, a characteristic reflection pattern is formed on irradiating the transparent layer at various angles. This pattern can be used for the identification and authentication process. In addition, the metal identification platelets are characterized by markings which can be viewed with the aid of magnifying techniques (e.g. a magnifying glass or a microscope): the metal identification platelets can be printed and/or have diffractive structures/patterns (such as a hologram) or they can be characterized by an arbitrarily shaped through-hole. The metal identification platelet is also characterized by its external shape (triangle, square, hexagon, circle, ellipse, letter, number, symbol, pictogram or any other conceivable form).

The microreflectors can be introduced into a transparent layer via known techniques. If the material from which the transparent layer is produced is, for example, a thermoplastic, it is for example possible to mix the thermoplastic with the microreflectors in an extruder (melt extrusion). If the material from which the transparent layer is produced is, for example, a lacquer which is liquid in its starting form it is, for example, possible to disperse the microreflectors in the liquid lacquer, to spread out the lacquer containing the dispersed microreflectors in the form of a film and to then cure the lacquer.

During the production of the security element according to the invention one step is preferably included in which the microreflectors in a layer are sheared in order to obtain random distribution with preferred orientation in the direction of shear. The direction of shear is preferably parallel to the surface of the subsequent transparent layer.

The security element according to the invention can also contain additional layers to the transparent layer. It is thus conceivable that one or more additional layers are arranged above and/or below the transparent layer. It is for example conceivable to arrange a so-called carrier layer underneath the transparent layer in order to provide the transparent layer with the necessary rigidity and/or dimensional stability to allow the handling of the transparent layer containing the microreflectors.

It is, for example, conceivable to arrange an additional transparent layer providing scratch resistance and/or UV stability above the transparent layer containing the microreflectors.

The surface of the transparent layer and the surface of the security element are preferably arranged parallel to each other.

In a preferred variant the security element according to the invention is in the form of a foil which can be attached to other foils for example by lamination and/or bonding and/or rear-side injection moulding.

In this form, the security element can be easily attached to an object and can therefore be used for many diverse and varied applications, such as for example in the form of a security foil in plastic cards and/or ID cards, as labels in or on packagings or as a component of electronic circuit boards etc. The security element preferably has a thickness of between 5 μm and 2 mm and a two-dimensional area of at least 0.25 cm² and at most 100 cm².

The security element has the property that the microreflectors are randomly distributed and/or orientated in the transparent layer. Thus, on viewing a security element which is tilted towards a light source, it produces reflections from various areas and/or at various tilt angles, depending on the site in which the security element has a microreflector whose reflective surface is orientated at an angle to the source of radiation and to the observer, so that the law of reflection applies. This effect cannot be reproduced by printing technology using inks and pigments, since pigments applied to a carrier by printing technology have the same orientation and are not tilted in relation to the carrier. When testing the authenticity of a security element according to the invention it is of crucial importance for various microreflectors to lighten up at various viewing angles, since the reflective surfaces of the microreflectors have various angles of inclination (orientations) in relation to the transparent layer. Reproductions obtained by printing technology or vapour-deposited metal particles would all lighten up at the same viewing angle.

The present invention also relates to the use of the security element according to the invention for authenticating and/or identifying objects, and preferably for the individualized authentication and/or identification of objects. For this purpose the security element according to the invention is preferably inseparably attached to an object to be protected. Preferably, any attempt to remove the security element from the object will lead to the destruction of the security element and/or the object. If the security element is in the form of a sheet, it can be attached to the object by bonding and/or lamination. Those skilled in the art of foil processing are aware of how to join foils by bonding and/or lamination in such a manner that a bond is formed which cannot be severed without destruction. In particularly preferred variants the object to be authenticated and/or identified can be a personalized security or identification document. Such security documents and preferably identification documents are for example ID cards, passports, drivers' licences, credit cards, bank cards, access control cards or other ID documents, without there being any limitation to these types of documents.

The security element can be recognizable as a marked region on or attached to an object. If the object is, for example, an ID card the security element could be in the form of a marked region on the ID card. Other marked regions are for example a hologram or a photo, from which it is immediately recognizable that this region contains the corresponding element. In a preferred variant the security element is integrated in the object in such a manner that it is not noticeable and/or obviously recognizable as such. If the object is, for example, an ID card in the form of a credit card the security element preferably extends over an entire side of the ID card or over both sides of the ID card. Preferably the security element is combined with other functions. Thus the security element can, for example, be partially printed. Even if the print covers some of the microreflectors the security element will already fulfil its function as long as a sufficiently large number of microreflectors are present and visible to serve as authentication and/or identification means. The combination of a print and the security element has the advantage that the printed image or part of the printed image can be used for positioning the security element according to the invention in relation to a source of electromagnetic radiation and a detector for identifying and/or authenticating the object by means of the security element. In addition, the combination of a printed image and the security element allows the simultaneous authentication/identification of the security element and the verification of the printed image (see also Example 4).

The present invention also relates to a method of authenticating (checking the authenticity of) the security element or an object to which the security element according to the invention is attached. Authentication is understood to be the process of checking (verifying) an alleged identity. The authentication of objects, documents, persons or data is the process of identifying that they are authentic—i.e. that they are unchanged, non-copied and/or non-forged originals. In its simplest form, authentication consists of checking for obviousness, i.e. a feature which is easy to check is examined for whether the object being viewed is an obvious forgery or not.

The security element according to the invention allows authenticity to be checked in various ways. The security element according to the invention is characterized in that it comprises a transparent layer in which a large number of microreflectors are arranged which can be identified by the naked eye. The microreflectors have the property that they reflect electromagnetic radiation with at least one wavelength if the arrangement consisting of the source of electromagnetic radiation, the at least one reflective surface of at least one microreflector and a detector for the reflected electromagnetic radiation complies with the law of reflection. The method according to the invention of authenticating an object by means of the security element according to the invention comprises at least the following steps:
(A) positioning the security element in relation to a source of electromagnetic radiation and at least one detector for electromagnetic radiation in such a manner that for at least some of the microreflectors the arrangement comprising the source, the reflective surface and the at least one detector complies with the law of reflection
(B) irradiating at least one part of the security element with electromagnetic radiation
(C) detecting the radiation reflected from the microreflectors

The electromagnetic radiation can be mono- or polychromatic. Preferably the electromagnetic radiation has at least one wavelength in the range from 300 nm to 1,000 nm, and particularly preferably in the range from 400 nm to 800 nm. The light source can be for example a laser, an LED, a halogen lamp, a filament lamp, a candle, the sun or another source of electromagnetic radiation which emits electromagnetic radiation with at least one wavelength in the range from 300 nm to 1,000 nm. Preferably a laser is used.

The radiation can cover an area or be in the form of lines or spots. Area-covering radiation means that a large portion of the security element is covered by the radiation, whereas spot-wise radiation means that only a small portion of the security element is covered by the radiation. The radiation profile can be correspondingly adjusted by techniques known to those skilled in the art, such as for example by the use of lenses or diffractive elements.

The detection of the reflected radiation is carried out using a sensor which is sensitive to the electromagnetic radiation employed, such as for example a photodiode or a phototransistor (a spot sensor), a camera sensor (a full frame sensor (CCD, CMOS)) or the like.

The advantage of the process according to the invention is that its simplest (qualitative) variant can be carried out by a human being without the use of machines. This variant is characterized in that the sun or a lamp or a candle or another light source is used as the source of electromagnetic radiation and the human eye is used as the detector. The security element is held by the viewer at an angle to the light source, so that individual microreflectors produce reflections. The viewer can tilt the security element towards the light source, so that the reflections disappear and new reflections optionally appear in another area of the security element. This allows a human being to readily confirm that the microreflectors visible to the naked eye are not forgeries produced by printing technology.

An additional advantage of the process according to the invention is that it can be carried out by or with the aid of a machine and allows a quantitative assessment. Verification by or with the aid of a machine makes it possible to check a larger number of security elements or objects with the aid of security elements within a shorter period of time and at a lower cost than when verification is conducted (solely) by a human being. In addition, verification by machine or with the aid of a machine allows a comparison to be made between reflection patterns of security elements which have been authenticated at various points in time.

In a preferred variant of the process according to the invention at least step (C) is carried out by a machine.

In an additional preferred variant the object to be authenticated and/or a radiation source and/or at least one detector are moved towards each other in order to record the microreflectors which blink in various areas and/or at various angles of orientation as a function of the relative position of the object (the security element) in relation to the radiation source and the detector. In this preferred variant the process according to the invention thus also includes the additional steps (D) and (E) following step (C):
(D) changing the relative position of the security element in relation to the radiation source and/or at least one detector, so that the law of reflection is fulfilled for a different portion of the microreflectors
(E) repeating steps (B) and (C) and where necessary also steps (D) and (E) until a sufficient number of reflective microreflectors has been detected

Changing the relative position of the security element in relation to the radiation source and/or the at least one detector can be carried out in such a manner that the radiation source and the at least one detector are held in a fixed (non-movable) position in relation to each other, whereas the security element (or the object) is moved in relation to the fixed arrangement of the detector and the radiation source. Both the movement of the fixed arrangement in relation to the object (the security element) and the movement of the object (the security element) in relation to the fixed arrangement are possible. It is also conceivable for the security element and the at least one detector to be held in a fixed (non-movable) position in relation to each other and to carry out a relative movement between the radiation source and the fixed arrangement of the security element and the detector. Additional combinations are also possible. Changing the position can be carried out in such a manner that the radiation source irradiates a different portion of the security element when its position is changed; it can however also be carried out in such a manner that the same portion of the security element is irradiated but at a different angle. It is also possible for the change in position to be conducted in such a manner that the same portion of the security element is irradiated at the same angle, while a detector scans the radiation reflected at a different angle. In all cases a different portion of the microreflectors is scanned when a change in position takes place.

Movement can be continuous at a constant speed, or it can be accelerated or come to a halt or it can be discontinuous, i.e. for example stepwise.

Steps (B), (C), (D) and (E) are repeated until a number of microreflectors sufficient for the purpose concerned has been scanned. If authentication is carried out for determining obvious forgery it is conceivable that only steps (A), (B) and (C) of the process according to the invention are carried out by positioning those microreflectors whose reflective surface is not parallel to the surface of the transparent layer in an arrangement in relation to the radiation source and the detector which fulfils the law of reflection. In such a case the only question checked is whether microreflectors are present which are not oriented parallel to the surface of the transparent layer, in order to be able to rule out forgeries obtained by printing methods.

If the use concerned is the identification of the object by means of the security element such a number of microreflectors must be detected that the reflection pattern can be unmistakably assigned to an object. More information on the identification of an object with the aid of the security element according to the invention is provided further below.

In an additional preferred variant of the process according to the invention the security element is fastened in a first step to a carrier which already has a predefined orientation in relation to a source of electromagnetic radiation and at least one detector. The carrier is of such a nature and can be positioned or is already positioned in such a manner in relation to the radiation source and the at least one detector that, after the security element according to the invention has been fastened to the carrier, some of the microreflectors are arranged in such a manner that the arrangement consisting of some of the microreflectors, the at least one detector and the radiation source fufil the law of reflection. The nature and properties of the carrier are predominantly determined by the object which is to be authenticated by the security element connected thereto. If the object is for example an ID card with a credit card format it is for example possible to use a flat surface as the carrier with an indentation into which the ID card can be placed. The position of the ID card on the carrier is clearly predetermined by the indentation. The radiation source and the detector are correspondingly arranged around the carrier in such a manner that the law of reflection is fulfilled for some of the microreflectors.

It is also conceivable to fasten an object such as an ID card in credit card format to a carriage as the carrier. The carriage can then be brought into a position in which the arrangement consisting of some of the microreflectors, a radiation source and a detector fulfils the law of reflection.

In an additional variant of the process according to the invention at least one laser is used as the radiation source. Laser light can be very effectively collimated and has high intensity. For the authentication process a focussed laser beam can be scanned over the security element. In this process it is possible both for the laser to be moved in relation to the object (the security element) and for the object (the security element) to be moved in relation to the laser. In a preferred variant of the process according to the invention at least one laser and at least one detector are arranged in a fixed position in relation to each other. The object is orientated in such a manner in relation to the fixed arrangement of the at least one laser and the at least one detector that the law of reflection is fulfilled for some of the microreflectors. The orientation can be simplified by means of a carriage. In a preferred variant the object is moved by means of a movably designed carriage in relation to the fixed arrangement of at least one laser and at least one detector. The movement is designed in such a manner that, as a result of the movement, various microreflectors successively produce reflections. It is conceivable to focus the laser beam on the security element and to guide the object past the laser beam. As a result, various regions of the security element are successively scanned by the laser beam. If the laser beam impinges on a microreflector whose reflective surface is orientated in such a manner that the arrangement of the reflective surface, the radiation source and the detector fulfil the law of reflection, this microreflector produces reflection at the moment of scanning which can be detected by means of the detector.

The scanning laser beam produces a defined profile on the security element. This profile can be circular, elliptical, lined, dumbbell-shaped or of any other shape.

Preferably the profile has a long and a short axis, as is for example typical of an elliptical, lined or dumbbell-shaped profile. The length of the short axis is in the order of the average size of the reflective surfaces of the microreflectors. The long axis is in the order of the average distance between two microreflectors. In the present context and hereinbelow, order of magnitude is understood to mean that two sizes either differ by a factor of below 10 and higher than 0.1 or are identical. Preferably the long axis is somewhat longer than the average distance between two microreflectors, and particularly preferably its size is in the range between 1 and 10 times the average distance between two microreflectors. The short axis is preferably somewhat longer than the average size of the reflective surfaces of the microreflectors, and particularly preferably its size is in the range between 1 and 10 times the average size of the reflective surfaces of the microreflectors.

In an additional preferred variant of the process according to the invention a security element is illuminated over its surface and the beams reflected from various microreflectors at various angles are detected with the aid of several spot sensors or with the aid of a full-frame sensor. This variant has the advantage that microreflectors can be detected in various locations and with various orientations without any relative movement being required between the security element and/or the radiation source and/or the detector.

In further preferred variant the process according to the invention includes the additional steps (F) and (G) following step (C) or (E):
(F) comparing the reflection pattern detected as a function of the relative position with at least one target pattern
(G) emitting a signal on the authenticity of the object as a function of the result of the comparison carried out in step (F)

The concrete nature of steps (F) and (G) is dependent on the application concerned. If the authentication process is an examination for obvious forgery it examines whether microreflectors are present whose reflective surfaces are not arranged parallel to the surface of the transparent layer. In such a case the target pattern according to the invention requires that individual reflections occur if the arrangement comprising the surface of the transparent layer, the radiation source and the detector does not fulfil the law of reflection. In step (G) the message as to whether the object is an obvious forgery or not can be in the form of a yes/no signal. It is for example possible to use a light signal for this purpose: If the object is not an obvious forgery a green light appears and if it is an obvious forgery a red light appears. Alternatively, an acoustic signal or another message which is detectable by the human senses can be used. If the purpose of the authentication is to verify the identity of a concrete object, a so-called 1:1 comparison between the reference pattern detected at a particular time and the reflection pattern of the presumed object (the target pattern) is required in step (F). The reflection pattern represents the reflections from the security element or part of the security element which are detected as a function of the position of the object in relation to the radiation source and a detector. The reflection pattern is therefore for example in the form of a numerical table in which the intensities of the radiation reflected back from the security element, as measured in various locations at various angles, are recorded. Such a numerical table can be compared directly with a target numerical table. It is also possible to prepare a different form of reflection pattern from the intensity distribution measured, using mathematical operations, before a comparison with a target pattern is carried out. Preferably Fourier transformation of the originally locally measured data is carried out, since the Fourier-transformed data display translational non-variance and higher positioning tolerance is therefore obtained.

It is possible to extract characteristic features from the intensity distribution in order to reduce the data volume. These characteristic features represent a form of fingerprint or signature of the security element. This signature is a digitally storable and machine-processible representation of the security feature. It is unmistakable, i.e. identical security elements produce the same signature; different security elements produce different signatures. The reflection pattern mentioned in step (F) can be a signature.

The comparison between the reflection pattern and at least one target pattern can be made on the basis of the complete numerical table or on the basis of characteristic features extracted from the numerical table. For this purpose it is possible for example to use known pattern matching processes in which similarities between the data sets are sought (see for example Image Analysis and Processing: 8th International Conference, ICIAP '95, San Remo, Italy, Sep. 13-15, 1995. Proceedings (Lecture Notes in Computer Science), WO 2005088533(A1), WO2006016114(A1), C. Demant, B. Streicher-Abel, P. Waszkewitz, “Industrielle Bildverarbeitung” (Industrial Image Processing), Publishers: Springer-Verlag, 1998, pp. 133 et seq, J. Rosenbaum, “Barcode”, Publishers: Verlag Technik Berlin, 2000, pp. 84 et seq, U.S. Pat. No. 7,333,641 B2, DE10260642 A1, DE10260638 Al, EP1435586B1). A special process is described in Example 4.

In a preferred variant of the process according to the invention at least steps (A) to (G) are carried out by machine (automatically). The following is an example of such an automatic variant: A user places an object in a defined manner on a carriage and starts the automatic procedure by pressing a button. The carriage is moved to a position—for example using a stepper motor—in which the surface of the security element, a radiation source and a detector form an arrangement in which the law of reflection is not fulfilled, but in which the radiation source, the detector and a hypothetical plane which is inclined at an angle γ to the surface of the security element, form an arrangement which does fulfil the law of reflection. If microreflectors are present in the security element which lie in this hypothetical plane, they would produce reflections if they were to be irradiated. Due to the spatial extent of the laser beam on the security element, the spatial extent of the sensor area of the detector and the comparatively small thickness of the transparent layer of the security element in relation thereto, all those microreflectors which do not lie in the hypothetical plane but are parallel thereto would also produce reflections. After the object has been brought into the corresponding position, the radiation source is activated, for example by a control unit, so that radiation impinges on one region of the security element. If microreflectors are present in this region with an orientation parallel to the abovementioned hypothetical plane, the detector detects reflections in the form of incident radiation of increased intensity. By means of the stepper motor the carrier can be moved and/or tilted further in order to detect additional microreflectors possibly having a different orientation. If the detector does not record any reflections the object is evidently a forgery. If reflections are recorded they can be stored via the control unit and/or computer unit in the form of a reflection pattern dependent on the position of the object. In a preferred variant a so-called shaft encoder is used which triggers the recording of the measured data. The shaft encoder detects the change in position and emits an impulse on any incremental change in position. If an impulse is emitted a measured value is recorded by the detector and stored. If the sensor is moved along a predefined path length the shaft encoder ensures that measured points are distributed over the path length at a constant distance from each other.

The reflection pattern recorded at a particular time can then be compared via the computer unit, optionally after smoothing and/or filtering and/or mathematical transformation, with at least one target pattern, such as for example a reflection pattern which has already been recorded at an earlier point in time and is stored in a database connected to the computer unit. The result of the comparison, i.e. the degree of conformity between the reflection patterns compared with each other, is then transmitted to the user in the form of a visible or audible message via an output unit (a monitor, a printer or a loudspeaker or the like), which is connected to the control unit or the computer unit.

The present invention also relates to a process for identifying a security element or an object according to the invention which contains a security element according to the invention. Identification is understood to be a process for unmistakably recognizing a person or an object.

The process according to the invention comprises at least the steps (A) to (C) and (F) to (G) already discussed in relation to the process of authenticating an object and the variants discussed in this regard, except that in step (G) a message is supplied concerning the identity of the object instead of its authenticity. Steps (D) and (E) are optional. If the security element is for example illuminated over its surface and if a sufficient number of microreflectors for the application concerned are simultaneously recorded with the aid of a full frame sensor as the detector, no change in position or detection of additional microreflectors is necessary. The process for identifying an object using the security element according to the invention thus includes at least the following steps:
(A) positioning the security element in relation to a source of electromagnetic radiation and at least one detector for electromagnetic radiation in such a manner that for at least some of the microreflectors the arrangement comprising the source, the reflective surface and the at least one detector complies with the law of reflection
(B) irradiating at least one part of the security element with electromagnetic radiation
(C) detecting the radiation reflected from microreflectors
(D) optionally changing the relative position of the security element in relation to a radiation source and/or at least one detector, so that the law of reflection is fulfilled for a different portion of the microreflectors
(E) optionally repeating steps (B) and (C) and where necessary also steps (D) and (E) until a sufficient number of reflective microreflectors has been detected
(F) comparing the reflection pattern detected as a function of the relative position with at least one target pattern
(G) emitting a message on the identity of the object as a function of the result of the comparison carried out in step (F)

In a preferred variant, steps (A) to (G) of the process according to the invention are carried out automatically (=by machine).

In step (F) of the process according to the invention the reflection pattern of the object viewed is compared with reflection patterns already determined at an earlier point in time. Thus, the identity of an object is determined by the reflection pattern and a comparison of the reflection pattern under observation with all the reflection patterns of already detected objects which are stored in a database (1:n comparison) is carried out.

Alternatively it is conceivable for the identity of the object to be determined by means of a different feature, such as for example by means of a bar code connected to the object and by comparing the reflection pattern measured at a particular point in time with the reflection pattern assigned to the identified object, for confirming the correctness of the assignment (authentication).

The present invention also relates to a device for identifying and/or authenticating an object by means of a security element according to the invention, which comprises at least one source of electromagnetic radiation and a detector for detecting the radiation reflected from the security element.

The source of electromagnetic radiation can emit mono- or polychromatic radiation. Preferably it emits electromagnetic radiation with at least one wavelength in the range from 300 nm to 1,000 nm, and particularly preferably in the range from 400 nm to 800 nm. A laser, an LED, a halogen lamp, a filament lamp, a candle, the sun or another source of electromagnetic radiation which emits electromagnetic radiation with at least one wavelength in the range from 300 nm to 1,000 nm can for example be used as the radiation source. Preferably a laser is used.

A sensor which is sensitive to the electromagnetic radiation employed, such as for example a photodiode or a phototransistor (spot sensor), a camera sensor (a full-frame sensor (CCD, CMOS)) or the like is used as the detector.

In a preferred variant a carriage is also present on which an object can be fixed. The carriage facilitates the positioning of the security element in relation to the radiation source and/or the detector. The carriage includes a region which is brought into contact with the object to be identified or authenticated. For this purpose the object is either placed on the carriage, hooked into the carriage or otherwise attached to the carriage, so that the object assumes a predefined, predictable orientation (position) in space. Due to the connection between the object and the carriage the security element connected to the object is either already in an arrangement which fulfils the law of reflection or it can easily be brought into such an arrangement by moving the carriage. In a special variant the carriage is for example a slide which can be brought into a first position in which the object and the carriage can be connected easily by a user and which can be brought into a second position in which microreflectors contained in the security element, the radiation source and a detector form an arrangement which fulfils the law of reflection.

In a particularly preferred variant the carriage is movable, so that the security element can be moved in relation to the radiation source and/or the detector, in order to be able to irradiate various microreflectors at the same angle or at different angles and to detect the reflections from various microreflectors at the same angle or at different angles.

In an additional preferred variant a laser is used as the radiation source and a phototransistor as the detector. The laser and the phototransistor are in a fixed arrangement in relation to each other. The object to be authenticated and/or identified can be moved on a movable carriage in relation to the fixed arrangement of the laser and the photodiode. The laser is arranged at an angle δ to the perpendicular to the surface of the security element. The detector is arranged at an angle δ to the perpendicular to the surface of the security element, wherein δ≠δ′. The laser, the perpendicular and the detector lie in the same plane. This arrangement comprising the laser, the surface of the security element and the detector does not fulfil the law of reflection, since δ≠δ′. Thus, in such an arrangement, microreflectors are detected whose reflective surfaces have an accordingly inclined orientation in relation to the surface of the security element. By moving the security element (by means of the carrier) various microreflectors are detected successively at a constant angle. Angle δ is in the range from 0° to 80° and preferably in the range from 0° to 60°. Angle δ′ is in the range from 0° to 80° and preferably in the range from 0° to 60°.

By means of the laser the security element is illuminated with a predefined spot profile. This profile preferably has a long and a short axis, such as for example in the case of an elliptical, lined or dumbbell-shaped profile. The length of the short axis is preferably in the order of the average size of the reflective surfaces of the microreflectors. The long axis is in the order of the average distance between two microreflectors. Preferably the long axis is somewhat longer than the average distance between two microreflectors, and particularly preferably it is in the range between 1 and 10 times the average distance between two microreflectors. The short axis is preferably somewhat longer than the average size of the reflective surfaces of the microreflectors and preferably it is in the range between 1 and 10 times the average size of the reflective surfaces of the microreflectors.

In a further preferred variant the device also includes a control unit which is connected to a computer unit and a database. The control unit is used for controlling the radiation source and optionally for controlling the movable carriage in order to be able to change the position of the object and to detect the signals recorded by the detector. In the database, reflection patterns of security elements are stored which can be used for a 1:1 or 1:n comparison. Using the computer unit, mathematical operations can be conducted on data sets and a comparison carried out between reflection patterns. Microprocessors are for example suitable for use as the computer unit and the control unit.

In a further preferred variant the device has at least one output, via which the result of a comparison can be transmitted to a user of the device in the form of a message. This output can for example be a lamp which lightens up when an obviousness test has revealed that the object is obviously a forgery. The output can also for example be a screen on which information is provided on the degree to which the reflection pattern of a security element detected at a particular time matches a reflection pattern from a connected database. Other outputs, such as for example a printer, a loudspeaker or other devices which are used as interfaces between a machine (a device) and a human being (the user) are conceivable.

The present invention has a number of advantages over the solutions known from the prior art for ensuring the authenticity of an object:
The security element according to the invention represents a combination of several security classes. The microreflectors are recognizable with the naked eye (overt), the distribution and/or orientation of the individual microreflectors is detectable by means of the device according to the invention (covert) and the shape and/or characteristics of the microreflectors can be analyzed by means of a magnifying device (covert, forensic).
The security element according to the invention provides a high degree of protection against forgery and/or reproduction since the randon distribution and/or orientation of the microreflectors is difficult to copy.
The security element according to the invention allows an examination of obviousness which can be carried out by any human being without the use of aids.
The security element according to the invention allows the individualization of an object, since the random distribution and/or orientation of the microreflectors is unique for each security element.
The security element according to the invention is inexpensive and can be attached to a large number of objects without having a negative effect on the design of the object.
The process according to the invention for authenticating an object and the process according to the invention for identifying an object using the security element according to the invention can be carried out by machine and quickly.
The device according to the invention is also cost-effective and can also be operated by human beings without any specialist knowledge after only a very brief demonstration.

The invention is hereinafter described in more detail by means of figures and examples, without being limited thereto.

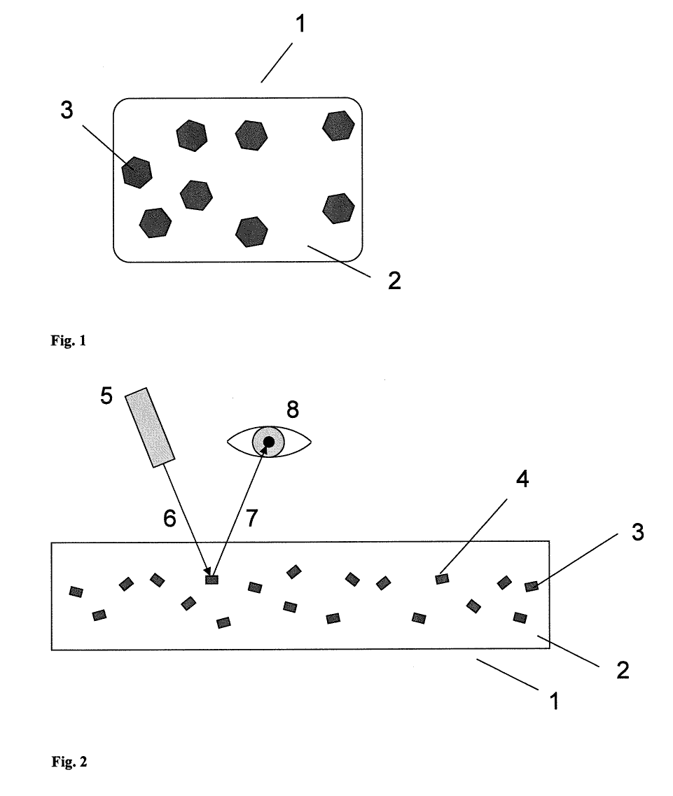

FIG. 1 depicts schematically a top view of an enlarged section of a security element (1) according to the invention which comprises a transparent layer (2) in which microreflectors (3) are contained in random distribution. In this variant the microreflectors have a hexagonal shape which can be viewed by means of a magnifying device (e.g. a magnifying glass or a microscope) for authentication purposes.

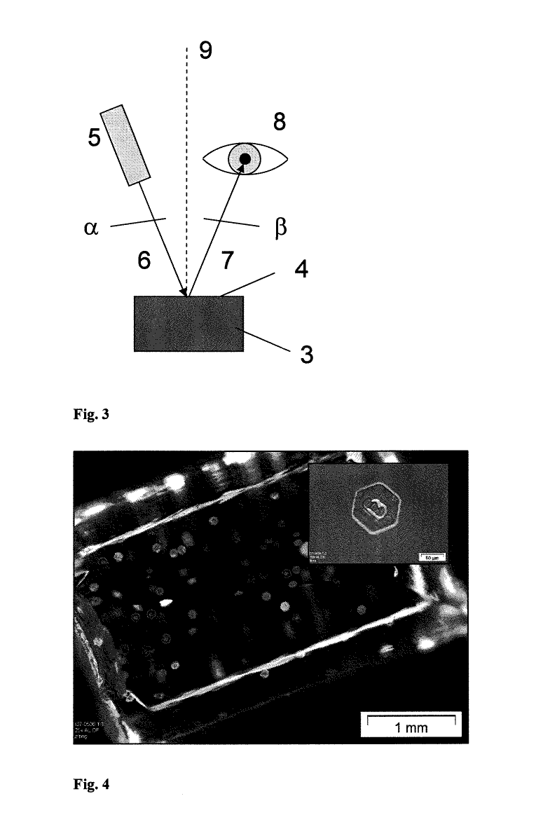

FIG. 2 depicts schematically a side view (cross-section) of an enlarged section of a security element (1) according to the invention. The security element has a transparent layer (2) in which microreflectors (3) are embedded. These are randomly distributed and the reflective surface (4) of each microreflector is randomly orientated. The security element can be irradiated by a source of electromagnetic radiation (5). In this process beams (6) impinge on the reflective surfaces and are reflected back therefrom. The reflected beam (7) can be captured by a detector (8). Only those surfaces which have a specific orientation towards the radiation source (5) and the detector (8) produce a signal in the detector (see FIG. 3).

FIG. 3 illustrates the law of reflection in relation to a microreflector (3). Electromagnetic radiation (6) impinges on the surface (4) of the microreflector (3) at an angle α to the perpendicular (9) to surface (4). The beam is reflected back (7) at angle β to the perpendicular (9) to surface (4). According to the law of reflection, angles α and β are identical in size. Using a detector (8) arranged in an appropriate position the specularly reflected radiation can be captured.

If the surface of the microreflector contains diffraction patterns, additional beams are formed in addition to the specularly reflected beam (the so-called zeroth order diffraction) at defined angles around the specularly reflected beam which are dependent on the diffraction patterns (higher diffraction orders). These diffracted beams usually have lower intensity than the specularly reflected beam. The diffracted beams can also be detected. If the security element having electromagnetic radiation of more than one wavelength is irradiated, beams with various wavelengths are diffracted at different angles. This allows wavelength-dependent detection.

FIG. 4 is a light microscopic photograph of a product of the incorporation of microreflectors into a polymer (the pellets from Example 1).

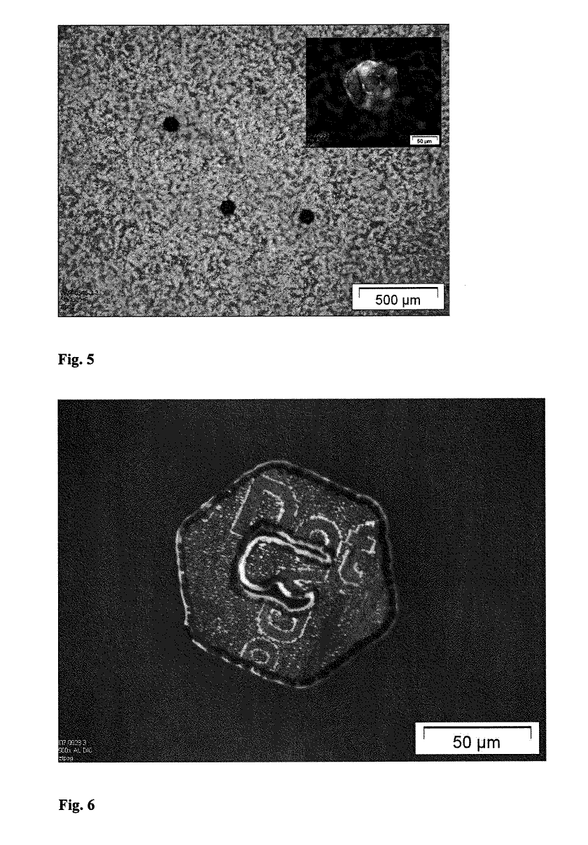

FIG. 5 is a light microscopic photograph of the film from Example 2.

FIG. 6 is a light microscopic photograph of a metal identification platelet in an ID card from Example 3.

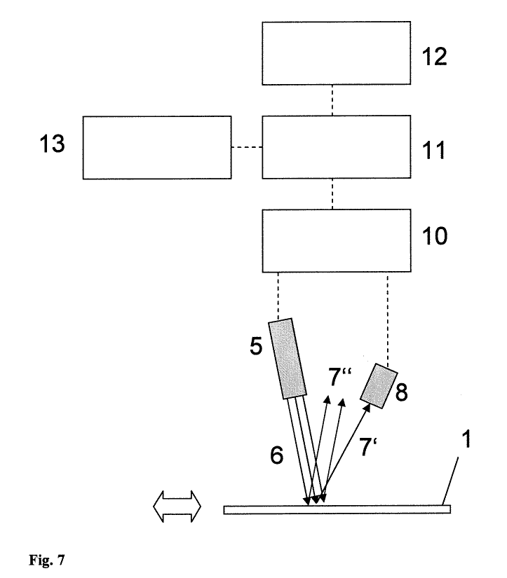

FIG. 7 depicts an example of a variant of the device according to the invention and the process according to the invention for authenticating and/or identifying objects by means of a security element according to the invention. The device comprises a source (5) of electromagnetic radiation, a detector (8) for electromagnetic radiation, a control unit (10) for controlling the radiation source (5) and for processing the signals measured by the detector (8), a computer unit (11) for carrying out mathematical operations and for comparing the reflection pattern of a security element (1) detected at a particular time with at least one target or reference pattern, a database (12) in which reference patterns and/or target patterns are stored for comparison purposes and an output (13) via which the result of a comparison can be transmitted to a user. Units 5, 8, 10, 11, 12 and 13 are connected to each other electrically, optically, via radio or via a different signal transmission channel (see the broken lines). The device also of course includes an input device via which a user can operate the device (not explicitly shown in FIG. 7). The input device can be a component part of the control unit or the computer unit. Two or more of the devices 10 to 13 can also be integrated in a device. It is also possible for the output device 13 to be connected directly to the control device 10.

The radiation source (5) and the detector lie in the same plane as the perpendicular to the surface of the security element. They are in a fixed (non-movable) arrangement in relation to each other and form, together with the surface of the security element, an arrangement which does not fulfil the law of reflection, i.e. radiation which impinges (6) on the security element is reflected back (7″) from the surface of the security element and from the boundary layers between the transparent layer and optionally other layers of the security element and does not enter the detector. On the contrary, the detector (8) is tilted by an angle of γ towards the beam 7″ (beams 7′ and 7″ enclose an angle γ). In this arrangement the detector (8) detects reflections (7′) from microreflectors whose reflective surface is inclined at an angle γ towards the surface of the security element. This ensures not only that the security element is not a forgery, in which microreflectors have been applied to the object by printing technology, but also that no radiation reflected from the surface of the security element enters the detector and produces an offset signal therein. This last feature provides considerable improvement in the signal-to-noise ratio. The angle γ is preferably in the range from 1° to 20°.

In FIG. 7 the security element is translationally moved (as schematically illustrated by the double arrow) beneath the fixed arrangement of radiation source (5) and detector (8), various regions of the security element (1) being thereby successively detected.

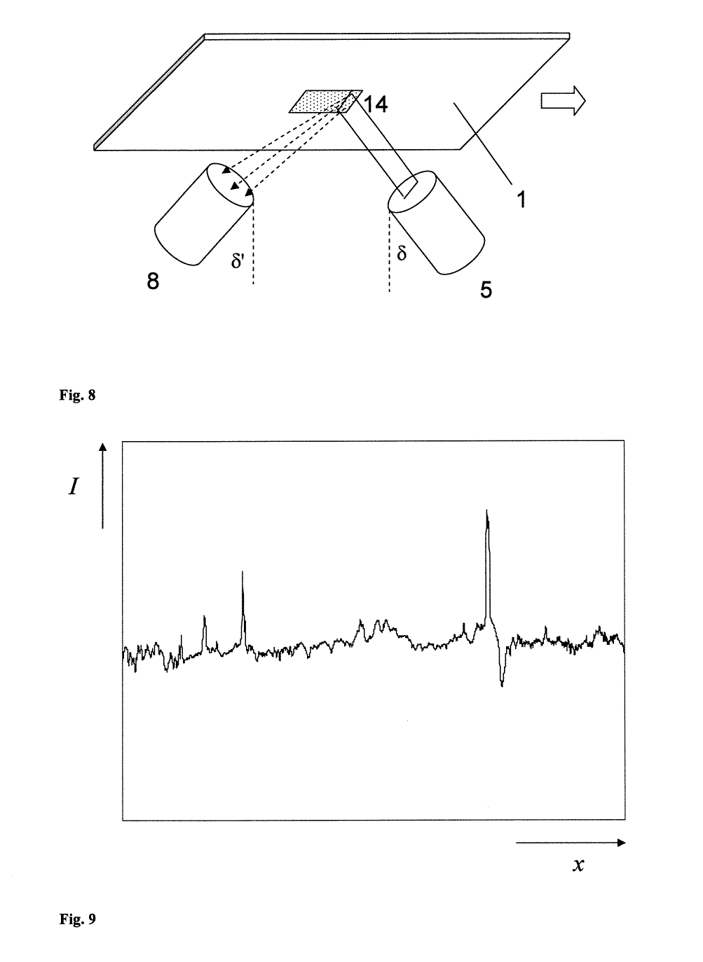

FIG. 8 shows the construction used in Example 4 for authenticating/identifying a security element (1) in the form of an ID card which is moved relatively in relation to a laser (5) and a detector (8) (the direction of movement is schematically illustrated by the thick arrow). During this movement, part of the card is irradiated and the radiation reflected from this surface (14) is detected.

FIG. 9 shows the intensity I of the radiation captured by the detector as a function of the path length x of a security element according to Example 3 (see Example 4).

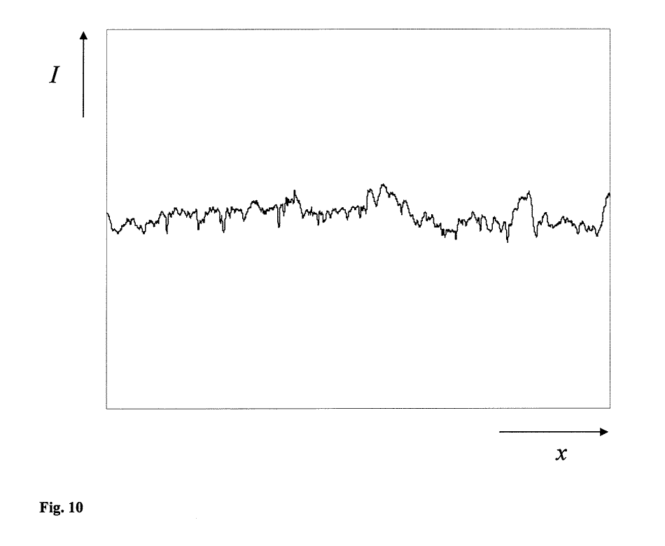

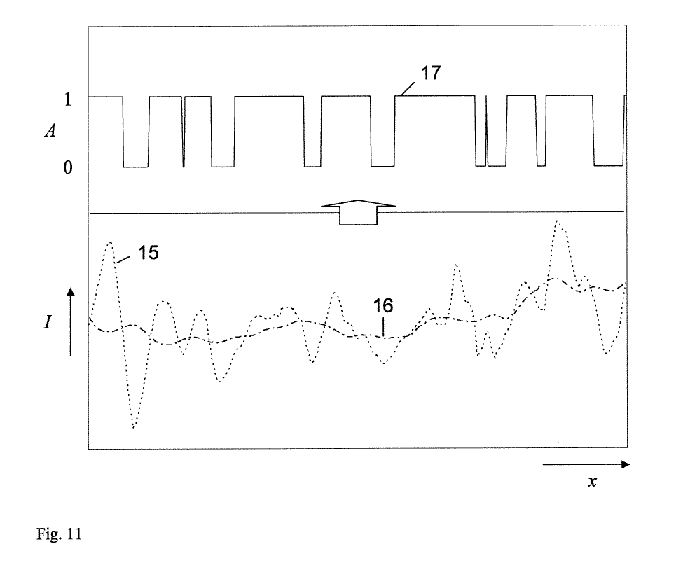

FIG. 10 shows the intensity d of the radiation detected by the detector as a function of the path length x of a white ID card without microreflectors (see Example 4).

FIG. 11 is a graphic depiction of an example of the production of zero crossovers for storage and/or comparison with other data sets. The dotted curve (15) is the originally measured intensity signal (optionally after filtering and smoothing) as a function of the path length concerned. By averaging the ±50 neighbouring values of each individual point in this curve the arithmetic average value is obtained, as shown by the dash-dotted curve (16). The crossing points between the original data (15) and the averaged data (16) form a so-called zero crossovers (the non-broken curve (17)). The zero crossovers as a function of the path length x are stored. They can be used for making comparisons with the corresponding data sets of additional security features for the purpose of identification and/or authentication.

### REFERENCE NUMERALS

1 Security element

2 Transparent layer

3 Microreflector

4 Reflective surface

5 Source of electromagnetic radiation

6 Incident radiation

7 Reflected radiation

7′ Radiation reflected from a microreflector

7″ Radiation reflected from the surface of the security element

8 Photosensitive detector

9 Perpendicular to the surface

10 Control unit

11 Computer device

12 Database

13 Output

14 Detected area (scanned area)

15 The intensity of the reflected radiation measured by the detector as a function of the path length x

16 Average values

17 Zero crossovers

α Angle of incidence

β Angle of reflection

### Examples

### Example 1

### Production of a Compound Containing Microreflectors

Hexagonal metal identification platelets with the designation “OV Dot B” made of nickel, with a thickness of 5 μm and a distance between oppositely facing sides of 100 μm, were used as the microreflectors. The platelets were printed, parts of the lettering “OVDot” being legible. A large “B” in the form of a through perforation was located in the centre of the platelets. The distance from the perforation to the sides was 25 μm and the perforation accounted for 12.5% of the total surface area of the metal identification platelet

A compound was produced with the metal identification platelets.

150 g of the metal identification platelets described above were mixed in an intensive mixer with 2.35 kg of Makrolon 3108 550115 powder (mean particle diameter 800 μm). Makrolon® 3108 550115 is of EU/FDA quality and contains no UV absorber. The melt volume flow rate (MVR) according to ISO 1133 is 6.0 cm³/(10 min) at 300° C. and a 1.2 kg load.

At a throughput of the extruder of 50 kg/hour 47.5 kg of Makrolon 3108 550115 cylindrical granules were extruded into barrel 1 of a ZSK twin-screw extruder. The metal identification platelet/Makrolon powder mixture was metered in through a side extruder. A transparent, particle-containing melt was obtained downstream of the 6-hole die plate, and after cooling in a water bath and strand pelletisation yielded 50 kg of cylindrical granules containing 0.3 wt. % of metal identification platelets.

A light microscopy image of a cylindrical granule pellet (FIG. 4) showed that the metal identification platelets were small, light-reflecting hexagons. No bent, damaged or even destroyed platelets could be recognized. Despite the shear forces and the temperature stress the through perforation in the form of a “B” remained undamaged. Also, the printing on the platelet was easily legible and was not affected by the processing temperature of 300° C. in the polycarbonate melt.

### Example 2

### Extrusion of the Compound to Form a Foil

A foil was extruded from the compound of Example 1.

The equipment used for the production of the foils consists of
a main extruder with a screw of 105 mm diameter (D) and a length of 41×D; the screw includes a degassing zone;
an adapter;
a slot die of 1500 mm width;
a three-roller smoothing calender with a horizontal roller arrangement, wherein the third roller can be swivelled by ±45° with respect to the horizontal;
a roller conveyer
a device for the bilateral application of protective film;
a draw-off device;
a winding station.

The compound of Example 1 was added to the feed hopper of the extruder. The melting and conveyance of the respective material took place in the respective cylinder/screw plasticization system of the extruder. The material melt was then fed through the adapter to the smoothing calender, the rollers of which were at the temperature given in Table 1. The final shaping and cooling of the film took place on the smoothing calender (consisting of three rollers). A rubber roller (fine-matt second surface) and a steel roller (matt sixth surface) were used for the structuring of the film surfaces. The rubber roller used for the structuring of the film surface is disclosed in U.S. Pat. No. 4,368,240 from Nauta Roll Corporation, USA. The film was then transported through a take-off device. Following this a protective film of polyethylene can be applied to both sides and the film can be wound.

TABLE 1
Process parameters

| Temperatures of the barrels of the extruder | 200 to 285° | C. |
|---|---|---|
| Z1 to Z9 | | |
| Temperature of dies Z1 to Z14 | 300° | C. |
| Temperature of the adapter | 290° | C. |
| Temperature of the melt | 285° | C. |
| Rotational speed of the extruder | 50 | min⁻¹ |
| Temperature of the rubber roller 1 | 15° | C. |
| Temperature of the roller 2 | 110° | C. |
| Temperature of the roller 3 | 140° | C. |
| Take-off speed | 26.3 | m/min |
| Throughput | 275.6 | kg/hour |

In order also to be able to investigate the finished film as regards its properties for laser printing, a laser additive was additionally incorporated in the film.

The following composition containing metal identification platelets and carbon black was fed to the extruder:

68.6 wt. % of Makrolon® 3108 550115 (PC from Bayer MaterialScience AG)

20.0 wt. % of master batch from Example 1 (with 0.3 wt. % of OV Dot “B” metal identification platelets)

11.4 wt. % of Makrolon® 3108 751006 (carbon black-containing PC from Bayer MaterialScience AG)

A transparent grey (laser-printable) extrusion sheet with a matt/fine-matt (6-2) surface, a metal identification platelet content of 0.06 wt. % and a thickness of 100 μm was obtained therefrom.

The metal identification platelets could clearly be recognized as small dark hexagons in the light microscopy image of the sheet (FIG. 5). The metal identification platelets were distributed uniformly and randomly over the whole foil surface. No aggregated/agglomerated platelets could be identified. Also, no damaged or even destroyed platelets were recognizable. Despite the shear forces and the temperature stress in the film extrusion, the through perforation “B” remained undamaged.

The shearing means that the metal identification platelets are not completely randomly oriented, but that they are randomly orientated around a preferential direction parallel to the surface of the foil. This random distribution around a preferential direction is particularly advantageous for the process according to the invention for authenticating and identifying objects, since a majority of the microreflectors are suitable for the process. Microreflectors which are orientated vertically to the surface of the transparent layer do not produce any reflections in the process according to the invention, since they are in an angle range for which no reflection measurements can be carried out. Such microreflectors do not fulfil any purpose; they are not functional. A preferential orientation parallel to the surface of the transparent layer, as obtained in the present example, has a high percentage of functional microreflectors.

The foil can be used as a security element according to the invention. It can for example be laminated to other foils to form a foil composite from which cards are punched which can be used as ID cards (see Example 3). The security element is therefore a fixed component of the object (the ID card) and cannot be removed therefrom without being destroyed.

### Example 3

### Lamination of a Foil Composite and Production of an ID Card

A foil composite was laminated from the following films:

| | |
|---|---|
| Core film | 375 μm Makrofol ID 6-4 colour 010207 (white) |
| One layer above and | |
| one below this: | |
| Film according to the | 100 μm film from Example 3, 6-2 |
| invention: | |
| Overlay film | 100 μm Makrofol ID 6-2, colour 000000 (natural) |

The films were laminated in a Bürkle press at 10 bar and 180° C. Then a card having the size of a credit card (shape ID-1) was punched out of the composite sheet. The metal identification platelets were then examined by light microscopy as regards their appearance.

In a light microscopy image of a metal identification platelet (FIG. 6) it could be seen that they had not been damaged or destroyed by the laminating process. Despite the pressure and the temperature stress during the lamination, the through perforation “B” remained undamaged. The printing on the platelet was clearly legible. The original surface structuring of the film was pressed smooth during the laminating process.

### Example 4

### Device and Process for Authenticating and Identifying an Object (an ID Card) using the Security Element According to the Invention

A device according to FIG. 8 was used. A Flexpoint® laser of type FP-65/5 (wavelength 650 nm, maximum power 5 mW) was used as the radiation source. The beam profile was lined and had a length of 2 mm and a width of 20

A Si-NPN phototransistor of type FT-30 from the STM company was used as the detector. An ID card produced according to Example 3 was used as the security element.

The laser was tilted at an angle of δ=45° to the perpendicular to the surface of the security element. The phototransistor was tilted at an angle of δ′=42° to the perpendicular to the surface of the security element.

The laser and the phototransistor were arranged in a fixed position in relation to each other. The security element was moved one centimetre in relation to the fixed arrangement (see the thick arrow in FIG. 8). The speed was about 1 cm per second. During the relative movement the security element was continuously irradiated with laser light, the longer side of the line-shaped beam profile being vertical to the direction of movement. During the relative movement 7,000 measured values (intensity of the reflected light) were detected by means of the phototransistor.

FIG. 9 is a graphic depiction of the result of the measurement. The intensity of the reflected light I is plotted against the path length x. Reflections in the form of sharp bands can be clearly recognized. The band height correlates with the orientation of microreflectors: Those microreflectors which are precisely orientated in such a manner that the laser source, the reflective surface and the phototransistor form an arrangement fulfilling the law of reflection display the highest intensity, whereas microreflectors which deviate slightly from the exact orientation display lower intensity in accordance with the deviation.

As a comparison, FIG. 10 depicts the result of a corresponding measurement carried out on an ID card without microreflectors. The procedure used is identical to that mentioned above. Sharp bands of the kind shown in FIG. 9 are not recognizable.

The curve shown in FIG. 9 is part of a characteristic reflection pattern of a security element. In a first step the untreated data are usually smoothed and/or filtered. It is for example possible to calculate the average of all values in a range of neighbouring values in order to reduce noise. In the present case the averaging of the ±5 neighbouring values is advantageous. In a second step data reduction (signal approximation) is carried out, i.e. the data are reduced to characteristic features. A special process will be briefly described at this point. In the so-called zero crossing process the average of all neighbouring values over a relatively large range is calculated. In FIG. 11, for example, the average (arithmetic average) of ±50 neighbouring values was calculated. The average values and the original values (optionally after being smoothed) are subtracted from each other. At those x coordinates at which this subtraction produces a change in sign, a so-called zero crossing occurs. This is stored as a function of the x coordinate and is used as a signature for the security element. This signature can finally be compared with other signatures in order to carry out identification [by a 1:n (one to many) comparison] or authentication [by a 1:1 (one to one) comparison].

It is possible that the security element also contains additional optical features such as a printed image in addition to the microreflectors. The signals emanating from such optical features are intermixed with the signals produced by the microreflectors. It is possible also to include other optical features, such as for example a printed image, in the analysis. This printed image can be used not only for positioning but also, in addition to the microreflectors, for authentication and/or identification. On irradiation with light, a printed image produces a light/dark pattern of the reflected light, which can be captured by the detector. The light/dark pattern can be used as a reference which indicates the relative position of microreflectors reflecting light at specific angles. The presence of the characteristic light/dark pattern can also be used for authentication or identification purposes.

1. A security element comprising
at least one transparent layer in which wherein a large number of microreflectors are randomly distributed, characterized in that wherein at least some of the microreflectors have at least one reflective surface which is not arranged parallel to the surface of the transparent layer.

2. A security element according to claim 1, wherein the size of the reflective surfaces of the microreflectors is in the range from 1×10⁻¹⁰ m² to 1×10⁻⁷ m².

3. A security element according to claim 1, wherein the average distance between two microreflectors is at least 5 times the average size of the reflective surfaces.

4. A security element according claim 1, wherein the reflective surfaces of the microreflectors are randomly orientated at angles in the range from 0° to 60° to the surface of the transparent layer.

5. A security element according to claim 1, wherein the microreflectors are platelet-shaped and as a result of shearing during the production of the security element are randomly distributed around a preferential orientation parallel to the surface of the transparent layer.

6. A process for authenticating and/or identifying an object by a security element according to claim 1, comprising at least the following steps:
(A) positioning the security element in relation to a source of electromagnetic radiation and at least one detector of electromagnetic radiation in such a manner that for at least some of the microreflectors the arrangement of the source, the reflective surface and the at least one detector complies with the law of reflection;
(B) irradiating at least one part of the security element with electromagnetic radiation;
(C) detecting the radiation reflected from microreflectors;
(D) optionally changing the relative position of the security element in relation to the radiation source and/or at least one detector, so that the law of reflection is fulfilled for a different portion of the microreflectors;
(E) optionally repeating steps (B) and (C) and where necessary also steps (D) and (E) until a sufficient number of reflective microreflectors has been detected;
(F) comparing the reflection pattern detected as a function of the relative position with at least one target pattern;
(G) emitting a message on the authenticity and/or identity of the object, depending on the result of the comparison carried out in step (F).

7. A process according to claim 6, wherein in step (D) the security element is moved in relation to a fixed arrangement of the radiation source and the detector.

8. A process according to claim 6, wherein the radiation source is arranged at an angle δ and the detector is arranged at an angle δ′ to the perpendicular to the surface of the security element, wherein δ≠δ′.

9. A process according to claim 6, wherein the radiation source is arranged at an angle δ and the detector at an angle δ′ to the perpendicular to the surface of the security element, wherein δ≠δ′.

10. A process according to claim 6, wherein the profile of the radiation impinging on the security element has a long and a short axis, and wherein the length of the long axis is in the order of the average distance between two microreflectors and the length of the short axis is in the order of the average size of the reflective surface of the microreflectors.

11. A process according to claim 10, wherein the movement is carried out vertically to the long axis of the beam profile.

12. A device for identifying and/or authenticating an object by means of a security feature according to claim 1, comprising at least one source of electromagnetic radiation, a detector for electromagnetic radiation, a carrier for receiving the object, a control unit and an output via which a message can be transmitted to a user.

13. A device according to claim 12, wherein the radiation source and the detector are arranged in a fixed position in relation to each other, whereas the carrier is movable in relation to the fixed arrangement of the detector and the radiation source.

14. A device according to claim 12, wherein characterized in that the radiation source is arranged at an angle δ and the detector is arranged at an angle 6′ to the perpendicular to the surface of the security element, wherein δ≠δ′.

15. A device according to claim 12, wherein the radiation source is arranged at an angle δ and the detector is arranged at an angle δ′ to the perpendicular to the surface of the security element, wherein δ≠δ′.

16. (canceled)

17. A method for using a security element having at least one transparent layer, wherein a large number of microreflectors are randomly distributed, and wherein at least some of the microreflectors have at least one reflective surface which is not arranged parallel to the surface of the transparent layer, for individualized authentication and/or identification of a personalized security or identification document.
